(19) United States
(12) Patent Application Publication
(10) Pub. No.: US 2013/0197728 A1
(43) Pub. Date: Aug. 1, 2013

(54) System for Monitoring the Operation of a Marine Propulsion System

(71) Applicant: Michael M. Blackwood, Oshkosh, WI (US)

(72) Inventor: Michael M. Blackwood, Oshkosh, WI (US)

(73) Assignee: Brunswick Corporation, Lake Forest, IL (US)

(21) Appl. No.: 12/979,011

(22) Filed: Dec. 27, 2010

Related U.S. Application Data
(63) Continuation of application No. 11/032,354, filed on Jan. 10, 2005, now abandoned.

(51) Int. Cl. G06F 19/00

(52) U.S. Cl. 701/21

(57) ABSTRACT

A monitoring and displaying system for a marine vessel calculates a variable that is equivalent to distance moved by the marine vessel as a function of rotation of the engine crankshaft. The variable is calculated by measuring boat speed and engine speed. In a typical application, the resulting variable is displayed in terms of inches of boat movement for one revolution of the engine crankshaft. This information is provided on a display monitor so that the operator of a marine vessel can continually monitor the effect on this variable by various changes that might be made to the marine propulsion system, such as a change in trim angle.

### BACKGROUND OF THE INVENTION

1. Field of the Invention

The invention is generally relating to a monitoring system for a marine vessel and, more particularly, to a monitoring system that provides information relating to the movement of a marine vessel as a function of the rotation of a crankshaft of an engine of the marine propulsion system.

2. Description of the Prior Art

Many different systems are well known for monitoring the operation of a marine vessel and a marine propulsion system of the marine vessel. The systems can be relatively simple, such as displaying the speed of the vessel, oil temperature, engine speed, or any other individual or combined parameters relating to the operation of the marine propulsion system of the vessel itself.

U.S. Pat. No. 4,633,803, which issued to Flowers on Jan. 6, 1987, describes a tachometer. An instrument gauge is described of the pointer output type that includes a display cover limiting observation of the pointer by a first window cut into the cover in the shape of a graphical representation of a proportional relationship between engine performance and revolutions per minute or vehicle speed. The window is oriented such that the pointer position indicates RPM or speed on a cover scale. Engine performance is indicated by the relative position of the pointer with respect to the curved shape of the window established by the proportional relationship.

U.S. Pat. No. 4,843,575, which issued to Crane on Jun. 27, 1989, describes an interactive dynamic real time management system. The system comprises a microprocessor adapted to sense real time inputs related to the condition of a powered system. Manual inputs are provided to the word processor and a long term memory is included. The memory stores historical data related to the real time inputs and the microprocessor compares sensed real time parameters with historical data to determine changes in certain unknown operating parameters.

U.S. Pat. No. 4,988,996, which issued to Ito on Jan. 29, 1991, describes a display system in a marine vessel or other vehicle which includes various means or sensors for detecting various operating and navigating conditions of the vessel or vehicle and a single displaying device for displaying information regarding one or more of these conditions.

U.S. Pat. No. 5,043,727, which issued to Ito on Aug. 27, 1991, describes a display system for a marine vessel. A display system is adapted to be embodied in a marine vessel having marine propulsion unit which is pivotally attached thereto for trim movement about a generally horizontal extending trim axis. The display system includes a trim angle sensor for detecting the trim angle of the propulsion unit and a trim angle display, preferably including both a graphical and a digital display, for precisely displaying information regarding the detected trim angle of the propulsion unit.

U.S. Pat. No. 4,914,945, which issued to Nakamura et al. on Apr. 10, 1990, describes a vessel speed detecting device. The device embodies a dynamic semiconductor pressure sensor that has high accuracies at most speed ranges and another speed sensor that has a higher degree of accuracy than the semiconductor pressure sensor at a certain range and that speed is displayed at that certain range.

U.S. Pat. No. 5,928,040,which issued to Wharton on Jul. 27, 1999, describes an apparatus for determining apparent slip of marine motor vessel propellers and method for doing same. A system for measuring propeller apparent slip includes a main console housing a processor. The system measures vessel speed with a pitot tube, pressure transducer, and the processor; and measures engine speed with an inductive pickup and the processor. The processor is preprogrammed with an algorithm for determining apparent slip. When the engine gear ratio and propeller pitch are manually provided to the processor, the processor computes apparent slip on a substantially real time basis. The processor routes information to a display screen in the main console and also to a data logger for permanent data storage.

U.S. Pat. No. 6,273,771, which issued to Buckley et al. on Aug. 14, 2001, discloses a control system for a marine vessel. A control system for a marine vessel incorporates a marine propulsion system that can be attached to a marine vessel and connected in signal communication with a serial communication bus and a controller. A plurality of input devices and output devices are also connected in signal communication with a communication bus and a bus access manager, such as a CAN Kingdom network, is connected in signal communication with a controller to regulate the incorporation of additional devices to the plurality of devices in signal communication with the bus whereby the controller is connected in signal communication with each of the plurality of devices on the communication bus. The input and output devices can each transmit messages to the serial communication bus for receipt by other devices.

U.S. Pat. No. 6,377,879, which issued to Kanno on Apr. 23, 2002, describes a system and method for encoding, transmitting, and displaying engine operation data. The vehicle data system collects, encodes, transmits, decodes, and displays engine and vehicle operation information. In one mode, an engine control unit of an outboard motor receives a plurality of engine and vehicle operation parameters from a plurality of sensors. The engine control unit encodes the plurality of parameters in a single signal and transmits the encoded signal to a display unit over a signal line. The display unit decodes the encoded signal to extract the plurality of parameters and displays the extracted parameters to the vehicle operator.

U.S. Pat. No. 6,458,003, which issued to Krueger on Oct. 1, 2002, describes a dynamic trim of a marine propulsion system. A method and system for defining a program to control the trim position of a propulsion unit mounted on a watercraft for a desired utility mode is described. Also, a method and system for defining a program to control the trim position of a propulsion unit mounted on a watercraft for a desired utility mode is described. Also, a method and system for controlling the trim position in a given utility mode by using the defined program is described. In defining the program, a first utility mode is defined and the watercraft is operated in the defined mode as in normal operation. Multiple trim positions are selected throughout the course of operation in the defined mode.

The patents described above are hereby expressly incorporated by reference in the description of the present invention.

It would be significantly beneficial if the operator of a marine vessel could be able to instantly determine the relationship between the current operating speed of an engine of a marine propulsion system and the actual movement of the marine vessel in response to the action of the engine.

### SUMMARY OF THE INVENTION

A method for monitoring the operation of a marine propulsion system of a marine vessel, in accordance with a preferred embodiment of the present invention, comprises the steps of measuring an operating speed of an engine of the marine propulsion system, determining a rate of movement of the marine vessel, and calculating a relationship between the rate of movement and the engine operating speed. The invention can further comprise the step of displaying this relationship for observation by an operator of the marine vessel.

The method can further comprise the step of calculating the elapsed time for N revolutions of a crankshaft of the engine and calculating a movement of the marine vessel during that elapsed time. The number N is equal to one in a particularly preferred embodiment of the present invention. The rate of movement of the marine vessel can be determined by a device selected from the group consisting of a GPS device, a speedometer which comprises a rotating wheel, and a pitot tube system. The relationship is measured in linear distance per N crankshaft revolutions of the engine.

A particularly preferred embodiment of the present invention provides a method that comprises the steps of determining an elapsed time of N revolutions of a crankshaft of an engine of the marine propulsion system, determining a distance traveled by the marine vessel during that elapsed time, and displaying the distance traveled by the marine vessel during that elapsed time. The elapsed time is determined, in a preferred embodiment of the present invention, by calculating the reciprocal of a rotational speed of the crankshaft of the engine. The rotational speed can be measured with a tachometer and the distance can be calculated by multiplying a measured speed of the marine vessel by the elapsed time.

The method of the present invention, in a preferred embodiment, comprises the steps of determining the distance traveled by the marine vessel during N revolutions of the crankshaft of an engine of the marine propulsion system and then displaying the distance traveled by the marine vessel during N revolutions of the crankshaft. The determining step can comprise the steps of determining an elapsed time of the N revolutions of the crankshaft of the engine, determining a distance traveled by the marine vessel during the elapsed time, and displaying the distance traveled by the marine vessel during the elapsed time.

### BRIEF DESCRIPTION OF THE DRAWINGS

The present invention will be more fully and completely understood from a reading of the description of the preferred embodiment in conjunction with the drawings, in which:

FIG. 1 shows the linear movement of a marine vessel;

FIG. 2 illustrates the individual steps and calculations used to perform the method of the present invention; and

FIG. 3 shows a highly simplified system that takes information from a tachometer and a speedometer and displays it on a display screen.

### DESCRIPTION OF THE PREFERRED EMBODIMENT

Throughout the description of the preferred embodiment of the present invention, like components will be identified by like reference numerals.

As is well known to those skilled in the art, marine vessels can be provided with numerous types of information display systems that allow the operator of the marine vessel to monitor various operating characteristics and parameters of both the marine vessel and its marine propulsion system. Engine speed, vessel speed, various temperatures and pressures, and other parameters of the system can be displayed on a video display for review by the operator of the marine vessel. As an example, the system described in U.S. Pat. No. 5,928,040, which is discussed above, calculates propeller slip and displays the mathematical result for view by the operator of the marine vessel. Although apparent propeller slip can be beneficial, if displayed for the operator of the marine vessel, it requires that both the pitch of the propeller and the gear ratio, between the engine crankshaft and the propeller shaft, be known and entered into the system in order to enable the calculation of apparent propeller slip. This requires that the monitoring and displaying system be specifically calibrated in accordance with the particular engine used in a specific application and the particular propeller used with the marine propulsion system. If the propeller is changed to a propeller with a different pitch, the monitoring and displaying system must be recalibrated. In addition, if the system is used in conjunction with a replacement marine propulsion system, such as an outboard motor, the gear ratio may have to be changed in the monitoring and displaying system. More fundamentally, the monitoring and displaying system described in U.S. Pat. No. 5,928,040 compares the action of a propeller to the movement of a marine vessel.

It is believed that a more direct relationship, between the engine itself and movement of the marine vessel, is a more effective way in which to monitor the operation of the marine propulsion system and display information to the operator of the marine vessel. By avoiding the need to utilize the gear ratio of the marine propulsion system and the pitch of the propeller, a more direct relationship can be provided to the operator of the marine vessel in which the linear movement of the marine vessel is compared directly to the rotation of the crankshaft of the engine, without involvement of the actual internal gear ratios of the marine propulsion system or the pitch of the propeller which, in certain circumstances, cannot be precisely determined.

By calculating and displaying the linear movement of the marine vessel as a function of the time it takes for the crankshaft to rotate about its axis, the operator of the marine vessel can quickly and easily monitor the effect, either beneficial or detrimental, from various changes made in the marine propulsion system, such as the trim angle of an outboard motor. In this way, the operator of the marine vessel can make small changes to the trim angle of the marine propulsion system and monitor the direct effect caused by those changes to the rate at which the marine vessel is propelled for each revolution of the crankshaft of the engine.

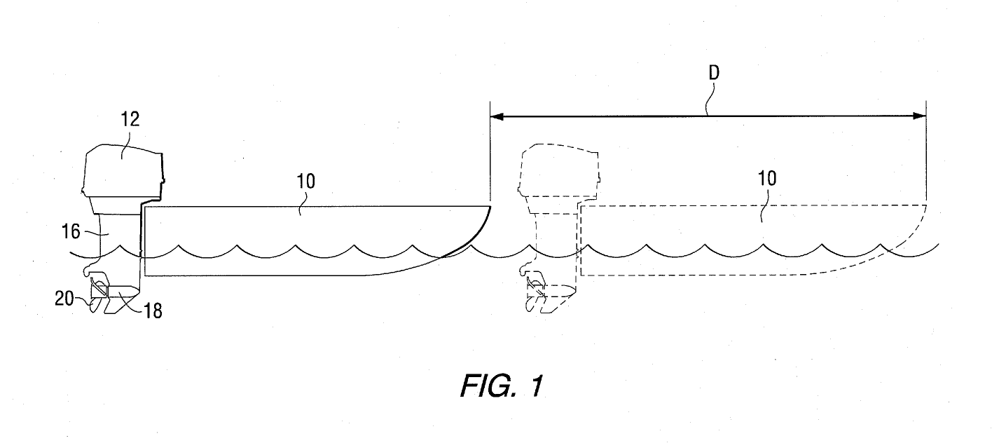

In FIG. 1, a marine vessel 10 is shown with a marine propulsion system 12 attached to its transom. The marine propulsion system 12 is illustrated as an outboard motor in FIG. 1 and has an engine under its cowl. A driveshaft housing 16 supports a vertical driveshaft which is driven by a vertical crankshaft of the engine. The vertical driveshaft supported by the driveshaft housing 16 is connected in torque transmitting relation with a horizontal propeller shaft within the gear case 18. A propeller 20 is attached to the horizontal propeller shaft to provide thrust for the marine vessel 10.

With continued reference to FIG. 1, a dashed line representation of the marine vessel 10 is shown in order to represent the position of the marine vessel after it has moved a distance D. As will be described in greater detail below, the distance D is used in conjunction with the preferred embodiment of the present invention in order to determine the linear distance moved by the marine vessel 10 during the revolution of the crankshaft of the engine. More precisely, the calculated variable that is displayed for use by the operator of the marine vessel describes a linear distance moved by the marine vessel during N revolutions of the crankshaft of the engine. In a most preferred embodiment of the present invention, N is equal to one. However, it should be understood that the displayed variable can represent a distance moved by the marine vessel 10 during a different number N of revolutions of the engine. Distance D in FIG. 1 is shown larger than would normally be employed in a preferred embodiment of the present invention.

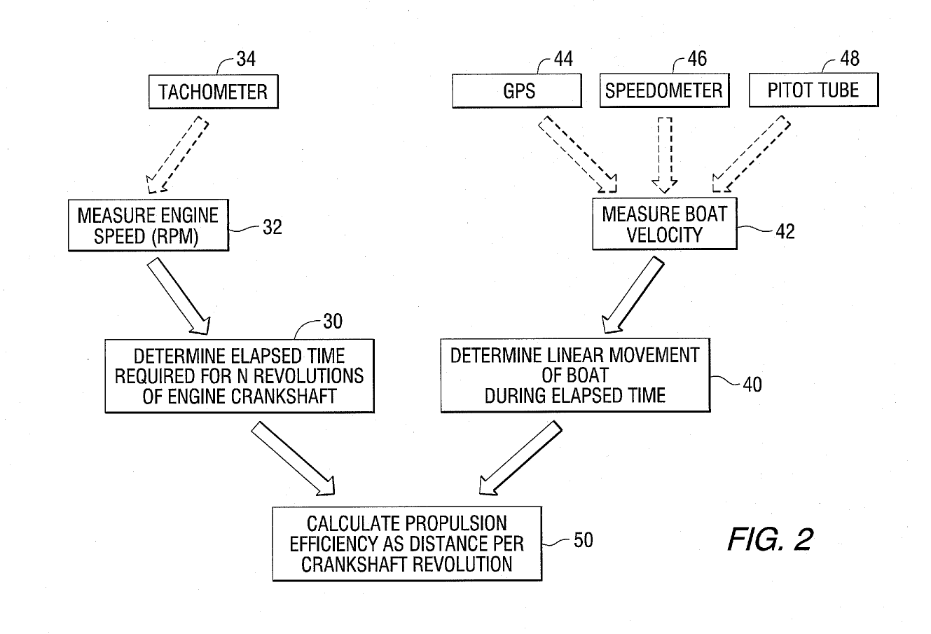

FIG. 2 is a highly schematic representation showing the various steps involved in displaying the variable that is provided by the present invention to represent a propulsion efficiency which is preferably displayed as a distance of travel of the marine vessel per N crankshaft revolutions. As shown in functional block 30, the present invention determines the elapsed time required for N revolutions of the engine crankshaft. This can be calculated by taking the reciprocal of the rotational speed (e.g. RPM). In order to perform the function in block 30, the engine speed is measured at functional block 32. This is typically accomplished by a tachometer 34. As shown in functional block 40, the present invention determines the linear movement of the boat, or marine vessel, during an elapsed time. This is accomplished by measuring the boat velocity at functional block 42. This can be done with a GPS system 44, a speedometer 46 which can have a rotating element that is caused to rotate by movement of the boat through the water, or a pitot tube system 48. When the elapsed time is calculated at functional block 30 and the linear movement of the boat is determined during the elapsed time at functional block 40, the present invention can calculate the propulsion efficiency as a boat movement distance per crankshaft revolution at functional block 50.

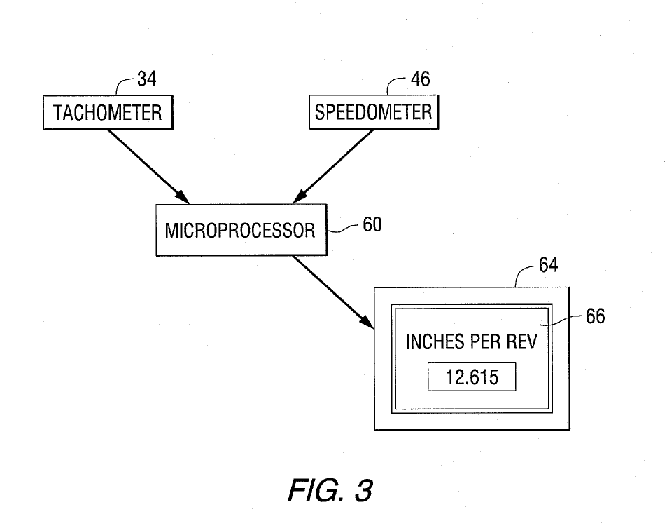

FIG. 3 illustrates one preferred embodiment of the present invention. A tachometer 34 provides an engine operating speed to a microprocessor 60. A speedometer 46 provides a boat speed to the microprocessor 60. The microprocessor, as will be described in greater detail below, calculates the movement of the marine vessel as a function of the elapsed time that it takes for the crankshaft to rotate N (e.g. one) times. The display 64 is used to provide this information to the operator of a marine vessel. On the display screen 66, the result is illustrated, hypothetically, as inches per revolution and the value is shown in FIG. 3 as 12.615 inches. This means that the marine vessel moved 12.615 inches during a single (i.e. N=1) revolution of the engine crankshaft. In this way, the operator of the marine vessel can make various optional changes in the marine propulsion system and monitor the effect of those changes. As an example, an outboard motor can be trimmed inwardly or outwardly from its current position while the operator monitors the value on the display screen 66 to see if the operation of the marine vessel was enhanced or diminished with regard to the displayed variable.

Equations 1-5, shown below, will be used to illustrate the simplicity of the calculations that result in this direct variable that allows the operator of the marine vessel to quickly and easily monitor the effect of various changes made to the marine propulsion system. In Equation 1, the engine speed is shown in units of revolutions per minute. This can easily be determined by a tachometer. Alternatively, other methods are available for a microprocessor to continually monitor the engine speed in terms of the rotational speed of the crankshaft of the engine. Equation 2 shows that the boat speed can be measured in miles per hour.

ENGINE SPEED=REVOLUTIONS/MIN (1)

BOAT SPEED=MILES/HOUR (2)

Equation 3, shown below, takes the reciprocal of the engine speed described above in conjunction with Equation 1. In addition, the units can be manipulated to use this reciprocal in units of seconds per revolution. As shown in Equation 4, the boat speed can be converted to units of feet per minute. The monitored variable of distance traveled by the marine vessel for each revolution of the engine, which is represented in equation five below, can be easily determined by multiplying the boat speed calculated in Equation 4 by the reciprocal of engine speed which is represented in Equation 3. This monitored and displayed variable can be maintained in units of feet per revolution or, more typically, in units of inches per revolution. Of course, this can be provided by simply multiplying the result by the appropriate unit conversion magnitudes.

1/(ENGINE SPEED)=(MIN/REVOLUTIONS)×(60 SECONDS/MINUTE) (3)

BOAT SPEED=(MILES/HOUR)×(5280 FEET/MILE)×(HOUR/60 MINUTES) (4)

DISTANCE/REVOLUTION=(BOAT SPEED)/(ENGINE SPEED) (5)

It can be seen that one of the significant advantages of the present invention is that it is not dependent on the gear ratio of the marine propulsion system. This gear ratio, which describes the ratio between the crankshaft of the engine and the propeller shaft, is necessary if propeller slip is used to monitor the performance of the marine propulsion system. Another advantage of the present invention is that it does not require knowledge of the pitch of the propeller used in the marine propulsion system. If apparent propeller slip is used as the monitoring variable, propeller pitch must be known. The present invention also provides a significant advantage because it requires only two variables to be measured. Boat speed can easily be measured by a speedometer or, in certain preferred embodiments of the present invention, by a GPS system. Engine speed is easily monitored by a tachometer. Both of these variables are typically available on a marine vessel and need not be added. By using these two standard measurements, the distance traveled by the marine vessel for each revolution of the engine can easily be calculated as described above in conjunction with Equations 1-5, and displayed for view by the operator of the marine vessel. Another significant advantage of the present invention is that it need not be customized to a particular marine propulsion system. Other systems known in the prior art require that the specific gear ratio of the marine propulsion system be known and be entered into the algorithm for calculating apparent propeller slip. Furthermore, the pitch of the propeller must be known and entered into that same algorithm. The present invention, on the other hand, can easily be used on any marine propulsion system as long as the engine speed and vessel speed can be measured. The present invention provides a measurement that directly ties the performance of the marine vessel to the operation of the engine so that the operator of the marine vessel can quickly and easily measure the effect of various changes made to the marine propulsion system, such as throttle position or trim position of the marine propulsion system.

As an example, if the engine speed is measured by a tachometer to be 4,000 RPM and the boat velocity is measured, by a speedometer, to be 40 m.p.h., the monitored variable is equal to 10.56 inches per crankshaft revolution. Alternatively, if the engine speed is measured to be 5,000 RPM and the velocity of the marine vessel is measured to be 50 m.p.h., the measured and displayed variable remains 10.56 inches per crankshaft revolution. However, if a change is made to the marine propulsion system which results in the engine speed again being measured at 5,000 RPM, but the boat velocity being measured at 60 m.p.h., the measured variable is equal to 12.672 inches per crankshaft revolution. In this way, the operator of the marine vessel can easily determine whether changes made to the marine propulsion system increase or decrease this magnitude which measures movement of the marine vessel as a function of one rotation of the engine crankshaft.

Although the present invention has been described in particular detail and illustrated to show a preferred embodiment, it should be understood that alternative embodiments are also within its scope.

1.-20. (canceled)

21. A method for displaying and dynamically monitoring propulsion efficiency of a marine propulsion system of a marine vessel regardless of propeller pitch and gear ratio, comprising:
providing a microprocessor and a display;
determining with the microprocessor the distance traveled by said vessel during N revolutions of a crankshaft of an engine of said marine propulsion system;
displaying on the display said distance traveled by said vessel during said N revolutions of said crankshaft of said engine; and
dynamically monitoring with the microprocessor distance per revolution as a measure of said propulsion efficiency.

22. The method according to claim 21 comprising:
determining speed of said engine;
determining, speed of said vessel;
determining said propulsion efficiency with the microprocessor by dividing, one of said engine speed and said vessel speed by the other of said engine speed and said vessel speed to obtain a quotient; and
dynamically monitoring with the microprocessor said quotient during operation of said marine propulsion system as said measure of said propulsion efficiency.

23. The method according to claim 22 comprising obtaining with the microprocessor said quotient by dividing said vessel speed by said engine speed, and dynamically monitoring with the microprocessor said quotient as indicating increasing propulsion efficiency with increasing values of said quotient during operation of said marine propulsion system.

24. The method according to claim 22 comprising obtaining with the microprocessor said quotient by dividing said engine speed by said vessel speed, and dynamically monitoring with the microprocessor said quotient as indicating increasing propulsion efficiency with decreasing values of said quotient during operation of said marine propulsion system.

25. The method according to claim 21 comprising:
determining an elapsed time of N revolutions of said crankshaft of said engine;
determining said distance traveled by said vessel during said elapsed time; and
dividing with the microprocessor one of
a) said distance traveled by said vessel, and
b) the number N of engine crankshaft revolutions,
by the other of said distance and said number N to determine said propulsion efficiency.

26. The method according to claim 21 comprising:
measuring, an operating speed of said engine by measuring the number N of revolutions of said crankshaft per unit time;
determining a rate of movement of said vessel by determining distance traveled by said vessel per unit time; and
calculating with the microprocessor said propulsion efficiency by dividing one of
a) said distance traveled by said vessel, and
b) said number N of crankshaft revolutions,
by the other of said distance and said number N, and providing, a quotient providing said propulsion efficiency.

27. A method for displaying and dynamically monitoring propulsion efficiency of a marine propulsion system of a marine vessel regardless of propeller pitch and gear ratio, comprising:
providing a microprocessor and a display;
determining with the microprocessor the distance traveled by said vessel during N revolutions of a crankshaft of an engine of said marine propulsion system;
displaying on the display a variable indicating said distance traveled by said vessel during said N revolutions of said crankshaft of said engine; and
dynamically monitoring with the microprocessor distance per revolution as a measure of said propulsion efficiency.

28. The method according to claim 21 comprising:
determining speed of said engine;
determining speed of said vessel;
determining said propulsion efficiency with the microprocessor by dividing one of said engine speed and said vessel speed by the other of said engine speed and said vessel speed to obtain a quotient;
displaying said quotient on the display; and
dynamically monitoring with the microprocessor said quotient during operation of said marine propulsion system as said measure of said propulsion efficiency.

29. The method according to claim 28 comprising obtaining with the microprocessor said quotient by dividing said vessel speed by said engine speed, and dynamically monitoring, with the microprocessor said quotient as indicating, increasing propulsion efficiency with increasing values of said quotient during operation of said marine propulsion system.

30. The method according to claim 28 comprising obtaining with the microprocessor said quotient by dividing said engine speed by said vessel speed, and dynamically monitoring with the microprocessor said quotient as indicating increasing propulsion efficiency with decreasing values of said quotient during operation of said marine propulsion system.

31. The method according, to claim 27 comprising:
determining an elapsed time of N revolutions of said crankshaft of said engine;
determining said distance traveled by said vessel during said elapsed time; and
dividing, with the microprocessor one of
a) said distance traveled by said vessel, and
b) the number N of engine crankshaft revolutions,
by the other of said distance and said number N to determine said propulsion efficiency.

32. The method according to claim 27 comprising:
measuring an operating speed of said engine by measuring the number N of revolutions of said crankshaft per unit time;
determining a rate of movement of said vessel by determining distance traveled by said vessel per unit time; and
calculating with the microprocessor said propulsion efficiency by dividing one of
a) said distance traveled by said vessel, and
b) said number N of crankshaft revolutions,
by the other of said distance and said number N, and providing a quotient providing said propulsion efficiency.
